(19) United States
(12) Patent Application Publication
(10) Pub. No.: US 2012/0028232 A1
(43) Pub. Date: Feb. 2, 2012

(54) METHOD FOR A VIEWER INTERACTIVE VOTING COMPETITION

(76) Inventor: Michael Findlay, Flushing, NY (US)

(21) Appl. No.: 13/273,192

(22) Filed: Oct. 13, 2011

Related U.S. Application Data
(63) Continuation-in-part of application No. 12/114,775, filed on May 4, 2008.

(51) Int. Cl. G09B 7/00

(52) U.S. Cl. 434/362

(57) ABSTRACT

A method for a viewer interactive voting competition is disclosed. Prospective contestants will submit auditions, which are commented and voted on prior to the competition. The performers with the most votes will become contestants, which must complete tasks dictated by the viewers and survive several rounds of competition. After each round of competition, viewers again vote to determine who will move onto the next round until a finalist is determined. Each voter can use a telephone, internet, email, or SMS to vote, and has a chance to win a prize with each submission.

### CROSS-REFERENCE TO RELATED APPLICATIONS

The present application is a continuation-in-part of and claims priority to U.S. patent application Ser. No. 12/114,775, filed on May 4, 2008, incorporated herein by reference.

### STATEMENT REGARDING FEDERALLY SPONSORED RESEARCH AND DEVELOPMENT

Not Applicable.

### FIELD OF THE INVENTION

This invention relates to a method for viewer interactive voting competition, and more particularly, to a competition where viewers vote to dictate the selected contestants, the tasks and challenges of the contestants, and the eventual winner of the competition.

### DISCUSSION OF RELATED ART

The entertainment industry has been constantly struggling to locate the next big talent. The traditionally accepted method to locate new talent is through talent calls and talent shows. The latter have become extremely popular, with dozens of talent competitions broadcasted on television for the public to enjoy. The entertainment provided by these competitions is primarily for the viewers to live vicariously through the wins and losses of the participants.

Traditionally, talent judges tour the country and select artists from different locations based on live auditions. The selected artists then perform live before the judges, the audience, and a national television audience and proceed based on their performances. Audience and viewership are the key factors in determining the financial success of a talent competition.

In an effort to further engage the audience, viewers are commonly able to vote for the contestants that they feel should proceed through the talent show. Viewers typically vote using various techniques such as SMS messaging, telephone calls or through internet voting. While their votes are not always absolute, viewers achieve a sense of interaction with the talent show. Unfortunately, auditions are typically performed before the show begins, with no viewer voting available, and many talented artists are eliminated without a chance for public review.

U.S. Patent Application No. US 2002/0091564 to Geller on Jan. 1, 2001, discloses a method of television audience interaction where viewers can vote online or by phone to participate in the selection process of prospective contestants. The amount of final votes for each contestant may be a combination of viewer votes and bonus points which are won by competition. While this reference does disclose a method of interactive voter participation, it is limited to determining the winner of the competition, and viewers cannot vote in real time to provide contestants with challenges set by the audience.

U.S. Patent Application No. US 2006/0292540 to Ehmann on Jun. 1, 2005, discloses a method and apparatus for analyzing selection criteria for forming a select talent group. The application provides an input device operably coupled to a talent group selector. The selector can compute the scores of the individuals of only two groups based on selection criteria and audition information. The apparatus includes an output device that has a display that lists the scores. This has the drawback that a person located far from the venue is deprived of his opportunity to vote for his favorite contestant. Moreover, said method can handle only a maximum of two groups.

While current viewer voting methods exist, they do not allow television viewers to interactively provide contestants with tasks and challenges in real time, they are limited to determining the winners only, and they do not allow the audience to vote on audition performances. Therefore, a need exists for a method where viewers vote to dictate the selected contestants, the tasks and challenges of the contestants, and the eventual winner of the competition.

### SUMMARY OF THE INVENTION

The present device discloses a method for a viewer interactive voting competition where viewers and audience members can vote to dictate the contestants of the competition, the tasks and challenges of the contestants, and the eventual winner of the competition. This is accomplished by holding a competition and providing audience members and viewers with several methods to provide their input to the competition.

Prior to the competition, auditions are available online for review by the general public, with voting and commenting of the auditions. At least one hundred contestants are selected according to their audition votes. The contestants are separated into at least ten groups, each group consisting of at least ten contestants. The plurality of groups compete to win a spot as finalists, with their tasks and challenges selected by the audience and viewers in real time.

After each task or challenge, the contestants receive votes by the audience and viewers based on their performance. At least one contestant is eliminated after each round. This process will continue until a winner has been determined. The entire process, from audition to winner, will be dictated by the audience and viewers of the competition.

Votes are received by phone, SMS, or internet. As an incentive for voting, viewers can receive prizes for their time. Furthermore, the voting method can receive audio or video auditions for those who wish to enter the competition, either by submitting a prerecorded file or by performing directly to the phone system.

These and other objectives of the present invention will become obvious to those of ordinary skill in the art after reading the following detailed description of the preferred embodiments. It is to be understood that the foregoing general description and the following detailed description are exemplary, and are intended to provide further explanation of the invention as claimed.

### DESCRIPTION OF THE DRAWINGS

FIG. 1 is a flow chart illustrating the audition process of the viewer interactive voting competition according to one embodiment of the invention;

FIG. 2 is a flow chart illustrating the task voting process of the viewer interactive voting competition according to one embodiment of the invention;

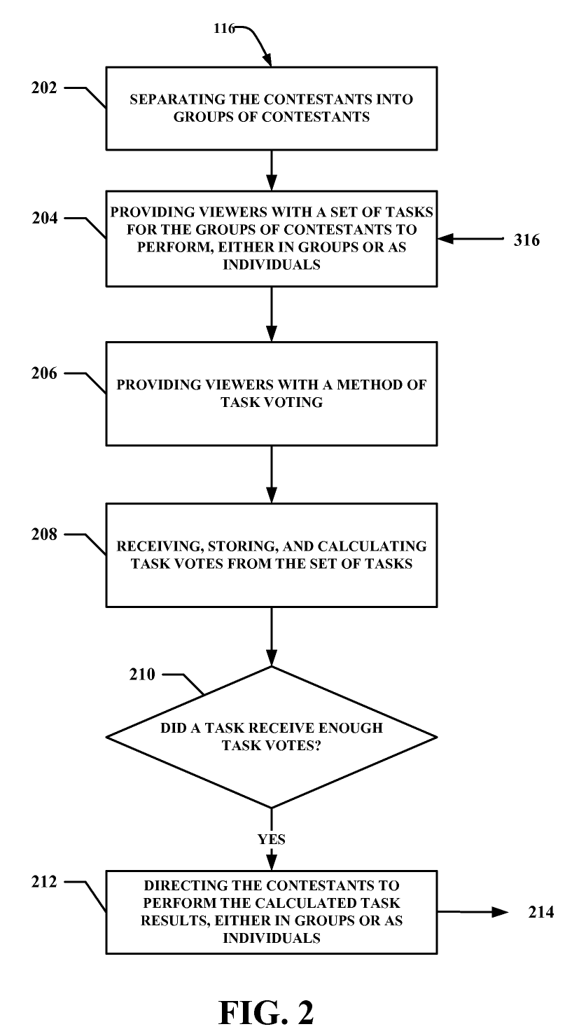

FIG. 3 is a flow chart illustrating the process voting process of the viewer interactive voting competition according to one embodiment of the invention.

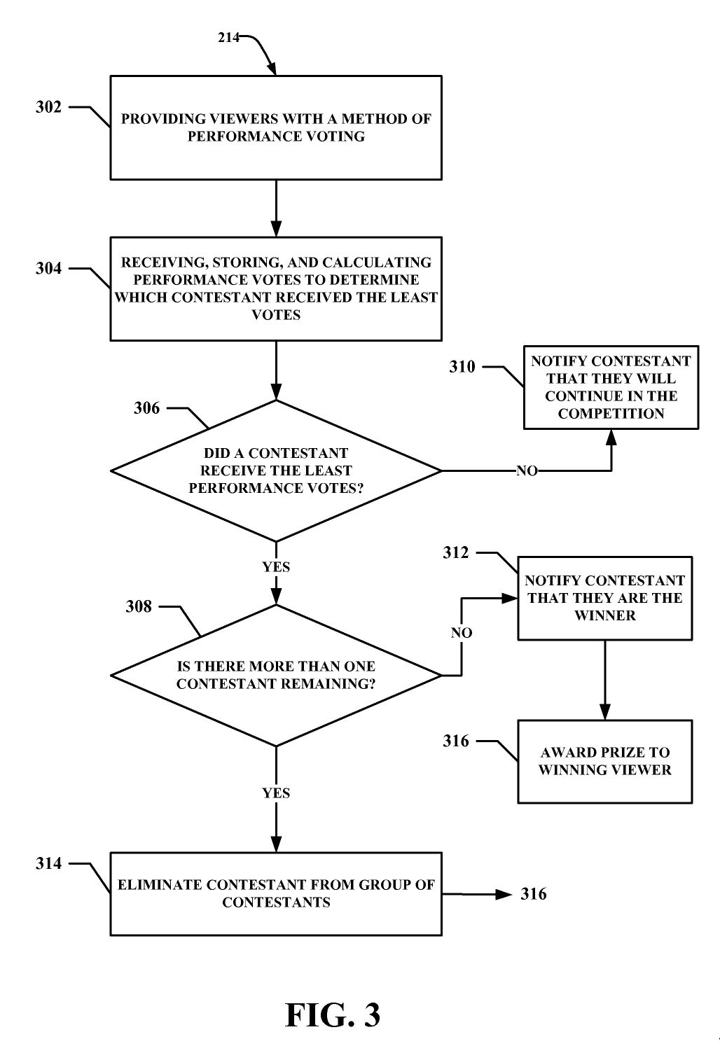

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

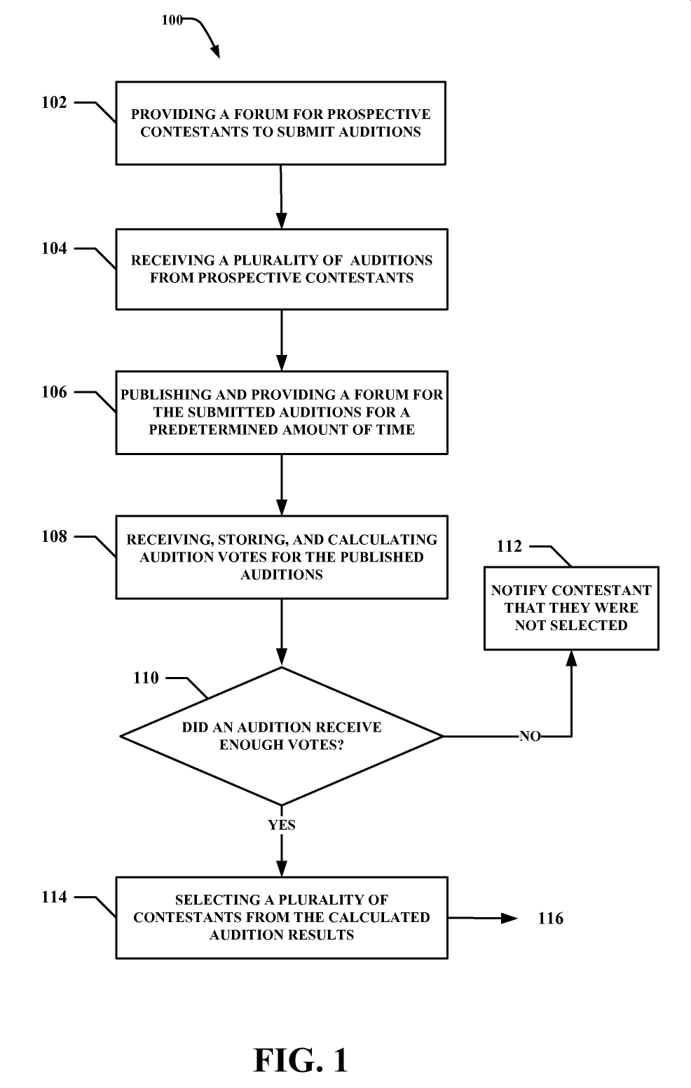

FIG. 1 provides a flow chart illustrating the present invention 100 in greater detail. A forum is provided for prospective contestants to submit their auditions 102. The forum can be a website, an email address, a telephone number, physical mailing address, or automated track layering machine. An automated track layering machine will receive a telephone call, play a musical track with or without vocals, and the user will sing into the telephone and have their voice recorded. The auditions are received 104 and published for a predetermined amount of time 106. During this time period, viewers can watch, comment, and vote on the auditions 106. The votes are received and stored on a storage device 108.

Once the predetermined time period ends for the published auditions, the auditions are removed and the total votes are calculated 108. Based on the results of the calculation 110, a plurality of contestants are selected 114. In the preferred embodiment, one hundred or more of the auditions receiving the highest amount of votes will be selected, although a set number of styles, genre, age, gender, location, or other consideration can be used. The contestants are then separated into groups 202. In the preferred embodiment, ten or more groups are created, with each group having ten or more contestants. These groups can further contain groups of contestants based on style, location, genre, age, gender or other consideration.

During the presentation of the competition, viewers are provided with a set of tasks for the groups of contestants to perform 204 and a method of voting on these tasks 206. In the preferred embodiment, a phone number, SMS number, website, or email address will be displayed during the presentation of the competition. The viewers will submit their task votes, which are received and stored on a storage device 208. Task voting submission includes receiving SMS messages, internet submissions, email submissions, or telephone submissions.

The task votes are calculated in real time and the tasks receiving the most votes are determined 210. The contestants are then directed to perform the tasks which received the most task votes during the competition, either in groups or as individuals 212. This real time aspect will provide viewers with an enhanced sense of interaction with the competition. In the preferred embodiment, the tasks are only presented to the viewers during the competition. In an alternative embodiment, the tasks are provided to the viewers before the competition for task voting, while task voting and calculation can be done either before or during the competition.

After the completion of the tasks, viewers are provided with a method of performance voting 302. This method, similar to task voting, includes a phone number, SMS number, website, or email address that is presented during the competition. The viewers will submit their performance votes, which are received and stored on a storage device 304. Performance voting submission includes receiving SMS messages, internet submissions, email submissions, or telephone submissions.

Similar to task votes, performance votes are calculated in real time and the contestants receiving the most votes are determined 304. The contestants will wait in anticipation in real time as their names are called if they receive a percentage of the votes which will ensure that they are not eliminated. The contestants which receive the least amount of votes 306 will be eliminated from the competition 314. Again, the real time aspect will provide viewers with an enhanced sense of interaction with the competition. In the preferred embodiment, at least one contestant from each group will be eliminated. In an alternative embodiment, the ten contestants who receive the least amount of votes will be eliminated, leaving unbalanced group numbers. In a further alternative embodiment, the contestant(s) will wait on an elimination stage as a random sequence of lights flashes on and off under their feet, with the lights eventually staying on if they received adequate performance votes and off if they are eliminated.

Each week, a new round of competition 316 will eliminate contestants 314 until only one contestant remains 312. A round of competition 312 comprises providing viewers with a set of tasks 204, receiving task votes from the set of tasks 206, storing the task votes on a storage device 206, calculating the tasks which receive the most task votes 206, directing the contestants to perform the computed task results 212, receiving performance votes 304, storing performance votes on a storage device 304, calculating the contestants which receive the least votes 304, and eliminating the contestants 314. Once only one contestant remains in each group, they will all be joined in a single group, with the rounds of competition continuing until only one remains 312. The entire process has been dictated by the viewers, from inclusion to tasks to selection. As an incentive, viewers who vote may win a prize at the end of the competition 316.

The storage and calculation of the votes is implemented on a computer system having a processor, system memory, and storage device such as a fixed disk drive, a floppy disk drive operative to receive a floppy disk, or a CD-ROM player operative to receive a CD-ROM.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

What is claimed is:

1. A method for a viewer interactive voting competition, the method comprising:
providing a forum for prospective contestants to submit auditions and receiving a plurality of auditions from prospective contestants;
publishing the submitted auditions for a predetermined amount of time, providing a forum for comments, and receiving audition votes for the published auditions;
storing the audition votes on a storage device and calculating the auditions which receive the most audition votes;
selecting a plurality of contestants from the computed audition results;
separating the contestants into groups of contestants;
providing viewers with a set of tasks for the contestants to perform, either in groups or as individuals, providing viewers with a method of task voting, and receiving task votes from the set of tasks;
storing the task votes on a storage device and calculating the tasks which receive the most task votes;
directing the contestants to perform the computed task results;
providing viewers with a method of performance voting, receiving performance votes and storing performance votes on a storage device; and
calculating the performance votes and eliminating the contestants in each group of contestants which receive the least votes of their group.

2. The method of claim 1, further comprising selecting at least one hundred contestants from the computed audition results.

3. The method of claim 1, further comprising selecting at least ten groups of contestants with at least ten contestants in each group.

4. The method of claim 1, wherein said forum for prospective contestants to submit auditions comprises a website, an email address, a telephone number, a physical mailing address, or an automated track layering machine.

5. The method of claim 1, wherein providing viewers with a method of task voting or performance voting comprises displaying a phone number, SMS number, website, or email address, and wherein receiving task or performance votes comprises receiving SMS messages, internet submissions, email submissions, or telephone submissions.

6. The method of claim 5, wherein the set of tasks are provided to the viewers during the competition.

7. The method of claim 6, wherein task votes are calculated in real time and the results are directed to the contestants during the competition.

8. The method of claim 1, wherein the set of tasks are provided to the viewers before the competition.

9. The method of claim 8, wherein the task votes are received, stored, and calculated prior to the competition.

10. The method of claim 1, wherein performance votes are calculated in real time and the results are directed to the contestants during the competition.

11. The method of claim 1, wherein a round of competition comprises providing viewers with a set of tasks, receiving task votes from the set of tasks, storing the task votes on a storage device, calculating the tasks which receive the most task votes, directing the contestants to perform the computed task results, receiving performance votes, storing performance votes on a storage device, and calculating the contestants which receive the least votes and eliminating the contestants.

12. The method of claim 11, further comprising providing several rounds of competition until only one contestant remains.

13. The method of claim 12, wherein at least one contestant from each group is eliminated after each round of competition.

14. The method of claim 13, further comprising regrouping the groups of contestants into a single group of contestants when all groups of contestants comprise a single contestant, and providing several rounds of competition until only one contestant remains.

15. The method of claim 1, further comprising entering viewers who submit audition votes, task votes, or performance votes into a drawing to win a prize.

16. The method of claim 1, wherein the contestants are selected based on style, location, genre, age, gender or other consideration.

17. The method of claim 1, wherein the contestants are separated into groups of contestants based on style, location, genre, age, gender or other consideration.
